(19) United States
(12) Patent Application Publication
(10) Pub. No.: US 2010/0102536 A1
(43) Pub. Date: Apr. 29, 2010

(54) Movable carrier for table saw

(75) Inventors: Chia-Sheng Liu, Taichung County (TW); Chieh-Yuan Tsai, Taichung County (TW)

Correspondence Address: BACON & THOMAS, PLLC, 625 SLATERS LANE, FOURTH FLOOR, ALEXANDRIA, VA, 22314-1176, US

(73) Assignee: DURQ MACHINERY CORP., Taichung (TW)

(21) Appl. No.: 12/318,363

(22) Filed: Dec. 29, 2008

(30) Foreign Application Priority Data
Oct. 29, 2008 (TW) 97141672

(51) Int. Cl. B62B 1/04; B62B 1/00

(52) U.S. Cl. 280/659; 280/63

(57) ABSTRACT

A movable carrier for combination with a table saw includes a retractable bar and two rollers. When the retractable bar is extracted and the rollers touch the ground, the table saw can be easily carried to move from one place to another. When the retractable bar is retracted, the movable carrier is spaceless and can prevent the table saw from collision.

### BACKGROUND OF THE INVENTION

1. Field of the Invention

The present invention relates generally to table saws, and more particularly, to a movable carrier for a table saw.

2. Description of the Related Art

Referring to FIG. 1, a general table saw 1 is composed of a chassis 2, a bench 3, and a cutting device 4. The table saw 1 is placed on an elevated bench 5 for operation. Because the table saw 1 is heavy, it usually cannot be moved at will.

However, when the table saw needs to be moved to another working place under some circumstances, it needs two or more people to move such heavy table saw, such that inconvenience will happen. Besides, the chassis 2 of the table saw 1 is usually made of metal or plastic; the former though provides stable support but weights the total weight; the latter though lightens the total weight but makes it vulnerable to collision.

### SUMMARY OF THE INVENTION

The primary objective of the present invention is to provide a movable carrier, which can easily move a table saw to another working place.

The secondary objective of the present invention is to provide a movable carrier, which can firmly support a table saw and strengthen the anti-collision of the table saw.

The foregoing objectives of the present invention are attained by the movable carrier composed of a framework, a retractable bar, a manipulation assembly, and two rollers. The framework is to support the table saw, having two parallel hollow base struts, each of which has at least one locate hole running therethrough. The retractable bar includes two extension tubes and a grip; the extension tubes are inserted into the corresponding base struts respectively; the grip is connected with the extensions. The manipulation assembly includes a switch, at least one link piece, and at least one locate piece. The switch is mounted to the grip, having a button shiftable between a drive position and a non-drive position. The link piece is movably mounted in the extension tubes, having one end connected with the switch. The locate piece is movably mounted to the extension tubes, opposite to the grip, and connected with the other end of the link piece. When the button is located at the drive position, the locate piece disengages from the locate hole to be located at a non-lock position. When the button is located at the non-drive position, the locate piece is engaged with the locater hole to be located at a lock position. The rollers are pivotably attached to the framework. A user can operate the manipulation assembly to extract the retractable bar and allow the two rollers to touch the ground in such a way that the user can easily carry the table saw to another working place.

### BRIEF DESCRIPTION OF THE DRAWINGS

FIG. 1 is a perspective view of a general table saw.

FIG. 2 an exploded view of a preferred embodiment of the present invention combined with a table saw.

FIG. 3 is an exploded view of the preferred embodiment of the present invention.

FIG. 4 is a perspective view of the preferred embodiment of the present invention, illustrating the retractable bar is not retracted.

FIG. 5 is an enlarged sectional view of a part of the preferred embodiment of the present invention before the button is pressed.

FIG. 6 is an exploded view of some parts of the preferred embodiment of the present invention.

FIG. 7 is an enlarged sectional view of a part of the preferred embodiment of the present invention.

FIG. 8 is a sectional view of a part of the first preferred embodiment of the present invention.

FIG. 9 is a sectional view of a part of the first preferred embodiment of the present invention.

FIG. 10 is similar to FIG. 5, illustrating the operation after the button is pressed.

FIG. 11 is similar to FIG. 4, illustrating that the retractable bar is retracted.

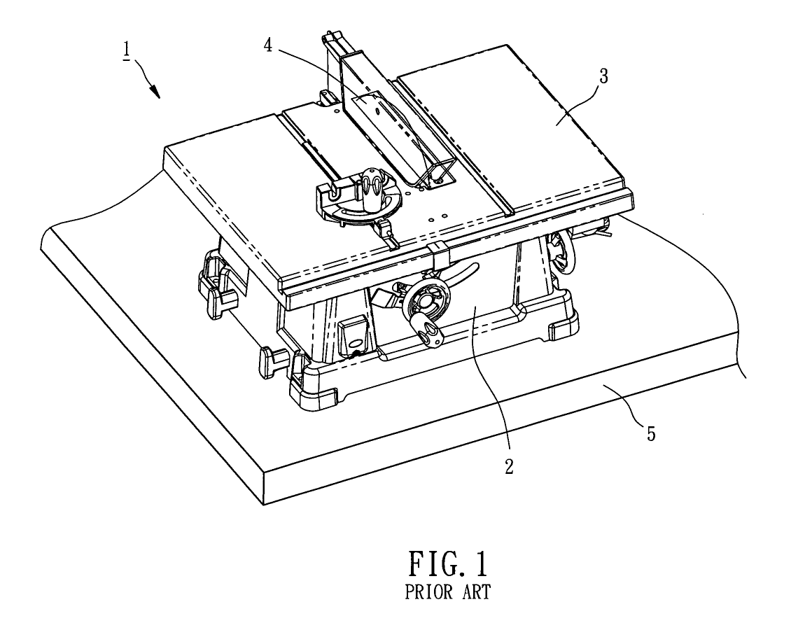

### DETAILED DESCRIPTION OF PREFERRED EMBODIMENTS

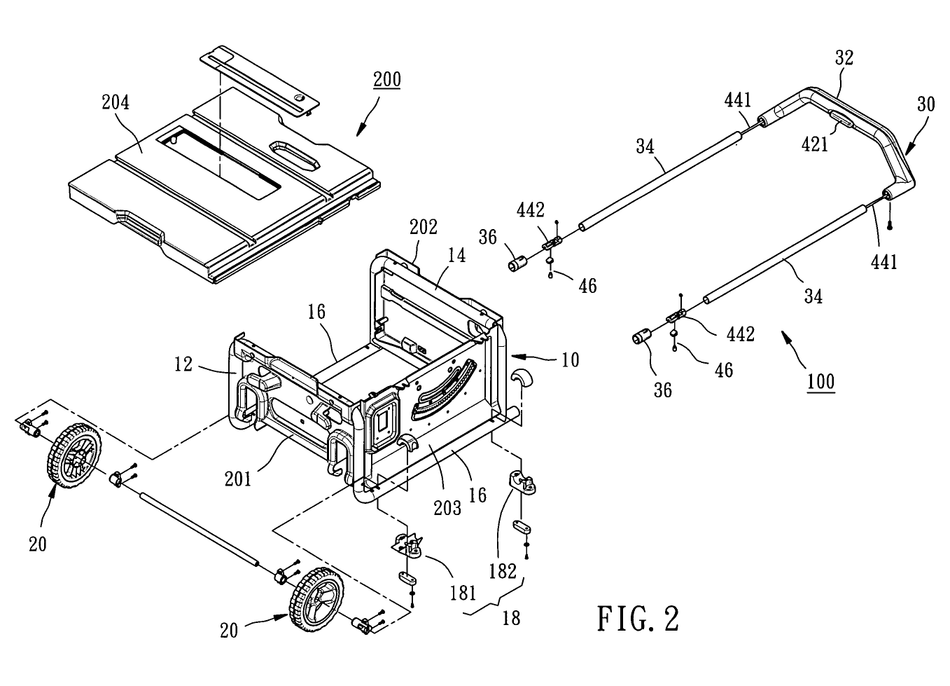

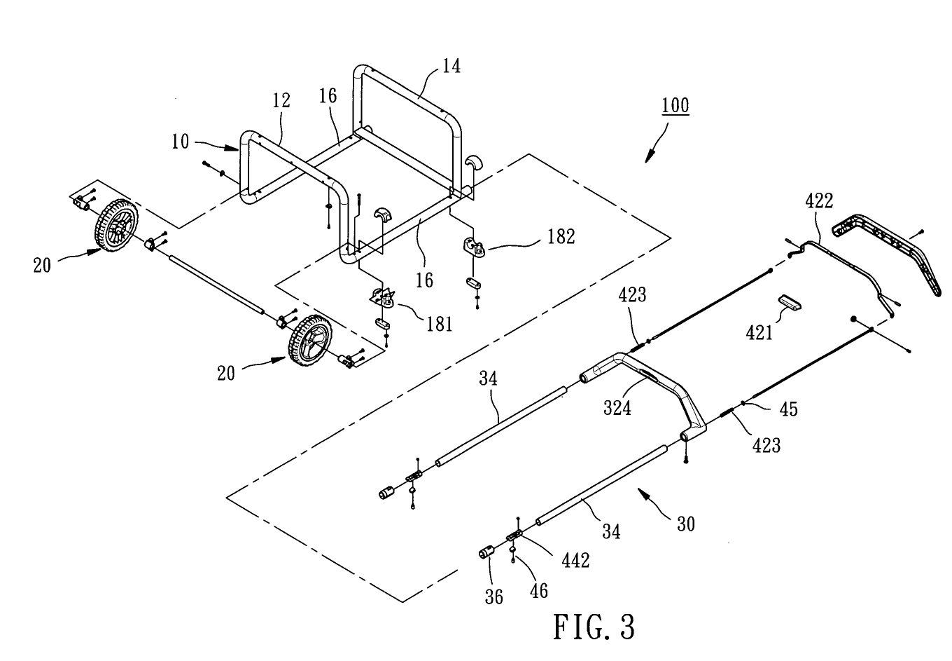

Referring to FIGS. 2 and 3, a movable carrier 100 for a table saw 200 is composed of a framework 10, a plurality of support pads 18, two rollers 20, a retractable bar 30, and a manipulation assembly 40. The table saw 200 is composed of a left plate 201, a right plate 202, a front plate 203, and a bench 204.

The framework 10 is formed of some metallic bars welded with one another, including an upright first strut 12, a second strut 14 perpendicular to the first strut 12, and two parallel base struts 16 fixedly connected with the first and second struts 12 and 14 horizontally. The left plate 201 of the table saw 200 is mounted to the first strut 12. The right plate 202 of the table saw 200 is mounted to the second strut 14. The front plate 203 is mounted between the first and second struts 12 and 14. The bench 204 is mounted to top edges of the left, right, and front plates 201, 202 & 203. It is to be noted that the framework 10 is not only to support the table saw 200 but also to prevent the left, right, and front plates 201, 202 & 203 from damage resulted from collision.

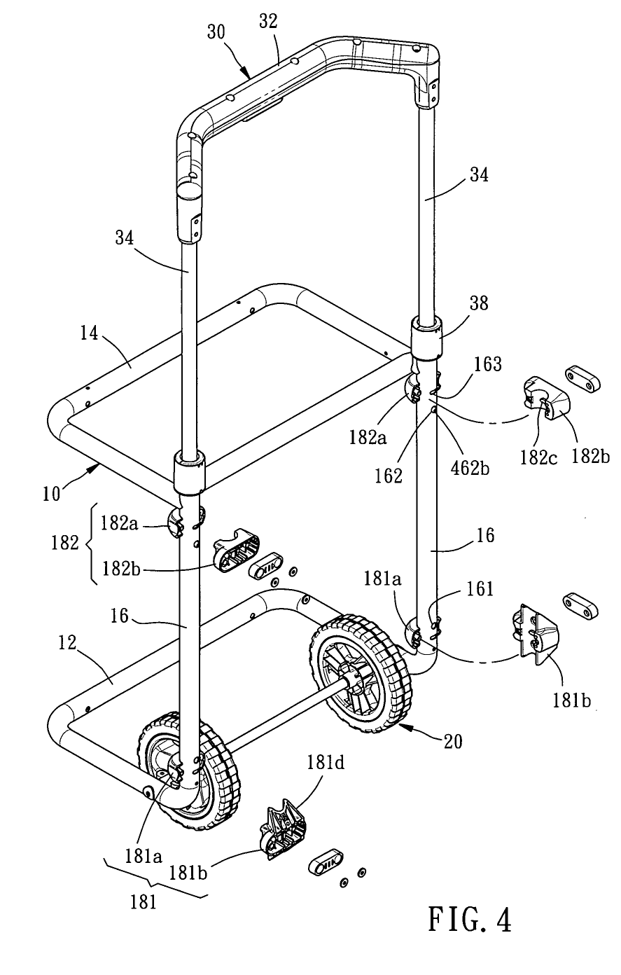

Referring to FIG. 4, the framework 10 includes a first locate hole 161 running through a bottom side of each of the base struts 16 and located close to the first strut 12, a second locate hole 162 running through the bottom side of each of the base struts 16 and located close to the second strut 14, and a slot 163 running through the bottom side of each of the base struts 16 and located close to the second locate hole 162 and closer to the second strut 14 than the second locate hole 162 is.

Each of the support pads 18 includes two front pads 181 and two rear pads 182. Each of the front pads 181 is formed of an upper part 181a and a lower part 181b, which jointly sheathe the base strut 16 and cover the first locate hole 161. The lower part 181b has a bevel 181d for allowing the movable carrier 100 to be carried through the stepped ground. Each of the rear pads has an upper part 182a and a lower part 182b, which sheathe the base strut 16. The lower part 182b has a stopper 182c located at an inner side thereof and inserted into the slot 163 to be engaged with the base strut 16.

The two rollers 20 are pivotably attached to the first strut 12 and each located close to one of the base struts 16 for conveniently dragging the movable carrier 100.

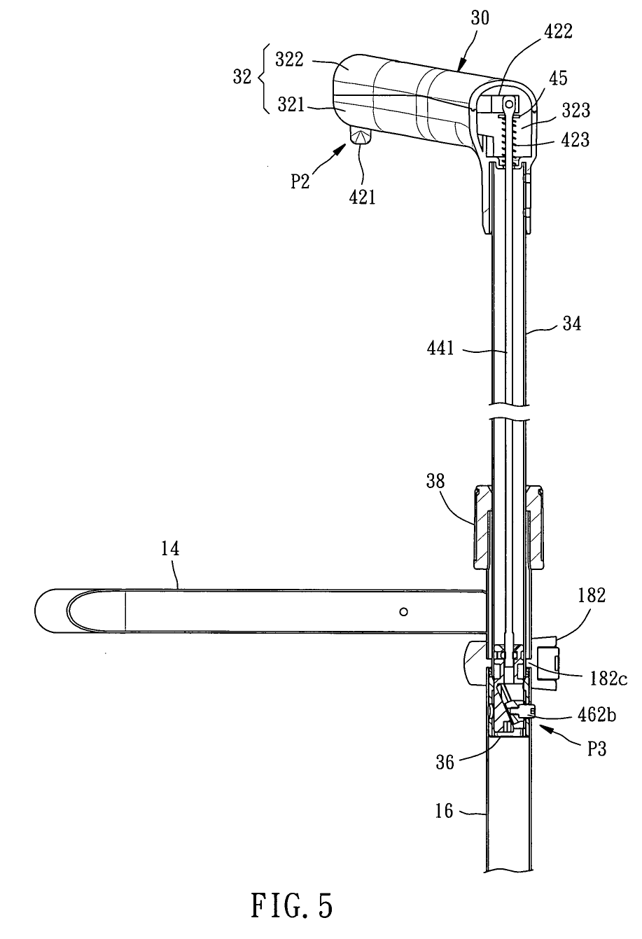

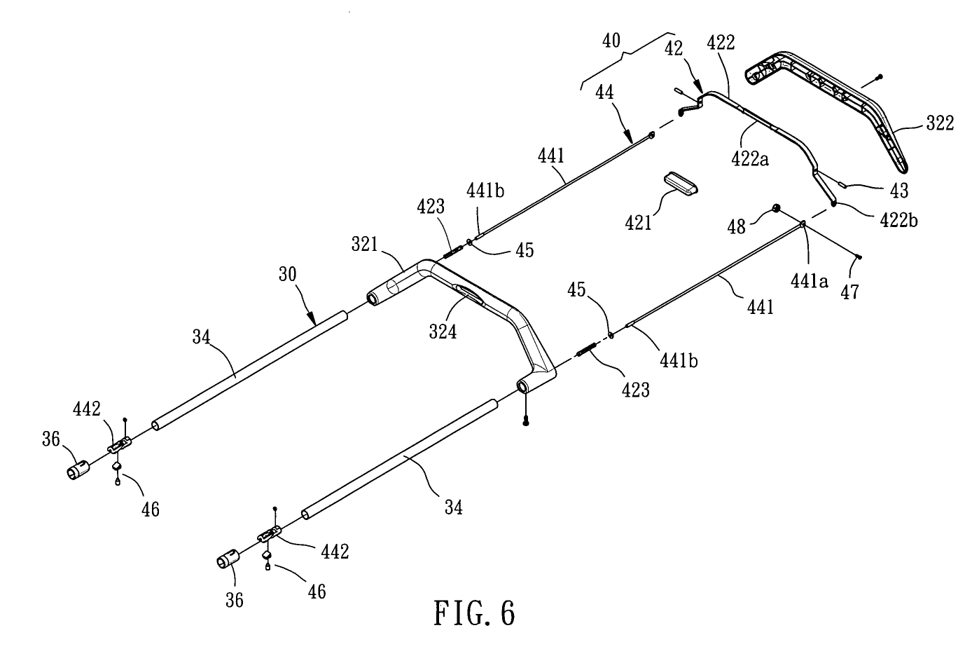

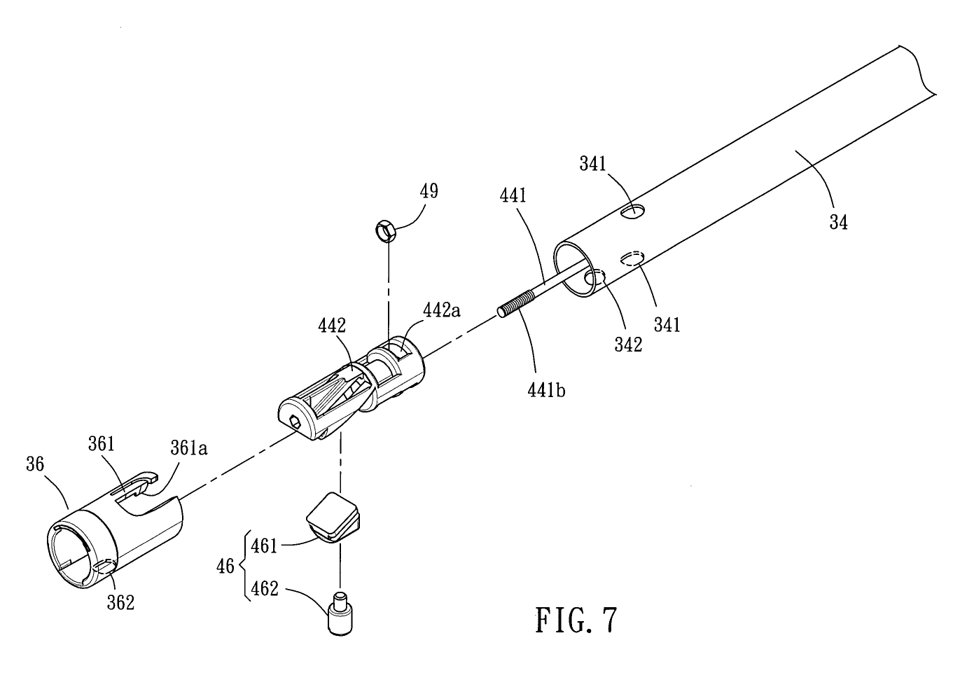

Referring to FIGS. 5 and 6, the retractable bar 30 includes a grip 32, two hollow extension tubes 34 each connected with one of two ends of the grip 32, two fasten sleeves 36, and two guide sleeves 38. The grip 32 has a part hogged toward the table saw 200, i.e. the grip 32 is vertically connected with the extension tubes 34, and has a base 321 and a cover 322, which are butted each other, having a chamber 323 formed inside. The base 321 has an opening 324 formed at a midsection thereof for communication with the chamber 323 and the two extension tubes 34. Each of the extension tubes 34 is inserted into the corresponding base strut 16 and has two opposite lock holes 341 and a first through hole 342 at free end thereof, as shown in FIG. 7. Each of the fasten sleeves 36 has two tongues 361 and a second through hole 362 and is fitted to one of the extension tubes 34. Each of the tongues 361 has a lock piece 361 a formed at an inner side thereof and engaged with the corresponding lock hole 341 in such a way that the fasten sleeves 34 do not disengage or rotate with respect to the extension tubes 34. The second through hole 362 is right aligned with the first through hole 342. Each of the two guide sleeves 38 has two ends, one of which is fitted to one end of the base strut 16 and the other is fitted to one end of the extension tube 34 for supporting the extension tubes 34.

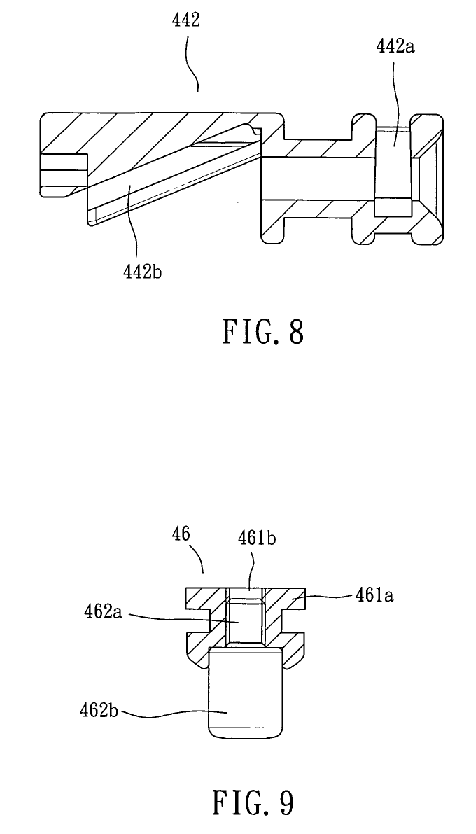

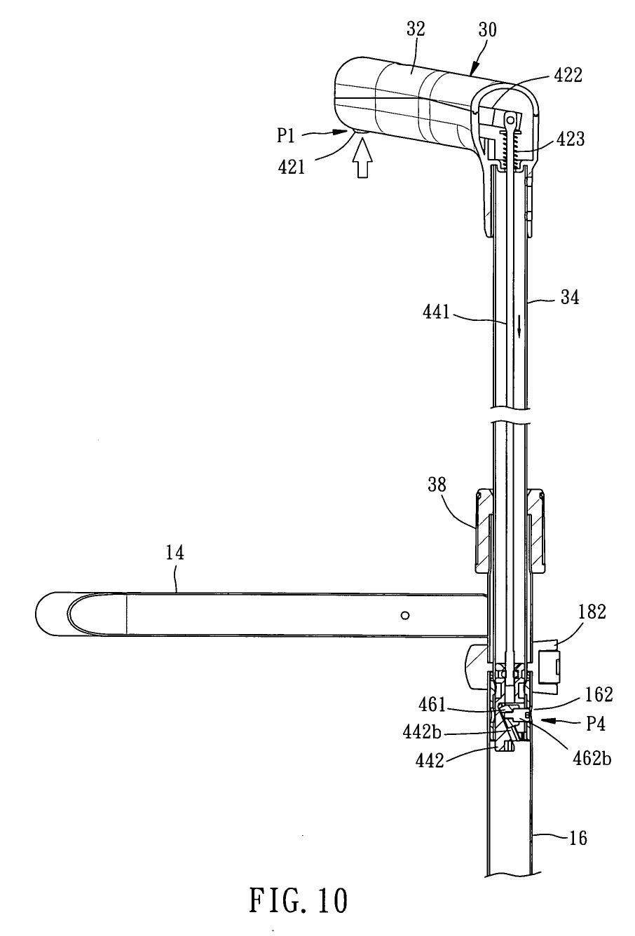

The manipulation assembly 40 includes a switch 42, two link pieces 44, and two locate pieces 46. The switch 42 is received in the chamber 323 of the grip 32, having a button 421, a slave piece 422, and two biasing members 423. Each of the biasing members 423 is a spring in this embodiment. The button 421 is mounted to the opening 324 of the grip 32 and can be shifted between a drive position P1 and a non-drive position P2, as shown in FIG. 10. When the user pushes the button 42, the button 42 is moved to the non-drive position P2 from the drive position P1. The slave piece 422 is an elongated member bended to correspond to the grip 32 in shape. The slave piece 422 is pivotably attached to the grip 32 by two axial pins 43 inserted through left and right sides of the slave piece 422 in such a way that the slave piece 422 is pivotable inside the chamber 323. The slave piece 422 has a midsection 422a located between the two axial pins 43 and stopped against a bottom end of the button 421. The slave piece 422 has an elongated hole 422b formed at a distal end thereof. Each of the two link pieces 44 is formed of a slender link 441 and a guide pusher 442. Each of the links 441 is inserted into the corresponding extension tube 34, having a pivot hole 441a defined as a first end of the link piece 44. A bolt 47 is inserted through the pivot hole 441a and the elongated hole 422b to be connected with a screw nut 48 in such a way that the links 441 are pivotably attached to the slave piece 422. Each of the links 441 has thread 441b at the other end thereof. Each of the springs 423 is fitted onto one of the links 441, as shown in FIG. 5, having two ends, one of which is stopped against an inner sidewall of the base 321 and the other is stopped against a washer 45; in this way, the resilience of the springs 423 is applied to the slave piece 422 to enable the slave piece 422 to force the button 421 to move toward the non-drive position P2. Referring to FIGS. 7 and 8, the guide pusher 442 has a sideward concavity 442a for receiving a screw nut 49. The screw nut 49 is threadably secured with the threads 441b of the links 441 to enable connection of the guide pusher 442 and the links 441. The guide pusher 442 further has an inclined guide groove 442b and is defined as a second end of the slave piece 44. Referring to FIG. 9, the locate piece 46 is formed of a limit piece 461 and a locate pin 462. The limit piece 461 has a rib 461a for coordination with the inclined guide groove 422b, and a thread hole 461b for threaded connection with a threaded body 462a of the locate pin 462. The locate pin 462 has a head portion 462b.

Referring to FIGS. 4 and 5 again, the retractable bar 30 is extracted with respect to the base strut 16, and each of the head portions 462b of the locate pins 462 passes through the second locate hole 162 to stop at a lock position P3 and the switch 42 remains at the non-drive position P2 without being pushed. In the meantime, the user can drag the movable carrier 100 by means of the rollers 20 to easily carry the table saw 200 from one place to another. In addition, the stoppers 182c of the rear pads 182 are inserted into the base struts 16 respectively to hold the fasten sleeves 36 and to prevent the retractable bar 30 from excessive extraction and then disengagement from the base strut 16.

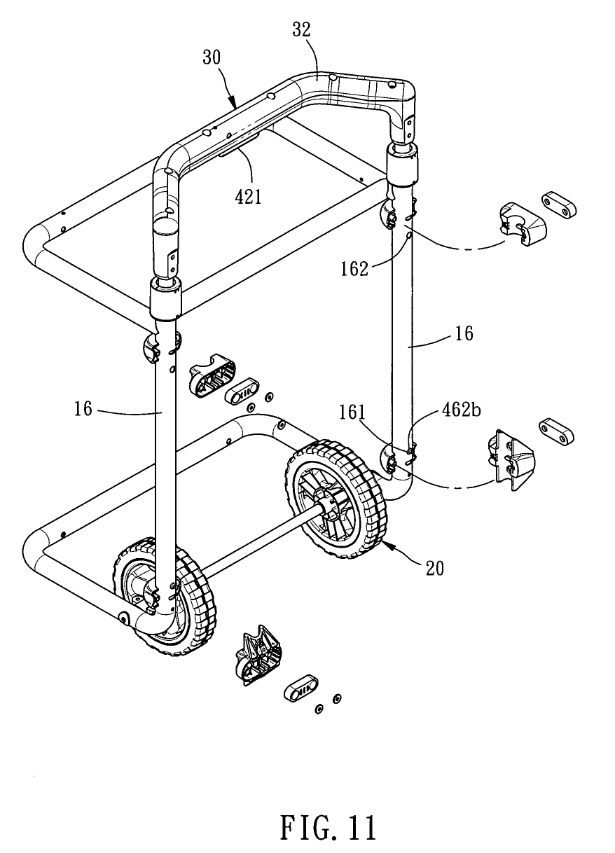

While intending to retract the retractable bar 30, the user can press the button 421 to switch it to the drive position P1; meanwhile, the slave piece 422 is forced to pivot and then the links 441 and the guide pusher 442 are driven to move toward the rollers 20; next, the inclined guide groove 442b guides the limit piece 461 to enable the locate pin 462 to move back to a non-lock position P4 along a diametrical direction of the base strut 16, i.e. the head portions 462b are no longer engaged with the second locate holes 162 respectively, as shown in FIG. 10. In the meantime, when the user pushes the retractable bar 30 and after the user releases pressing the button 421, the resilience of the springs 423 indirectly drives the links 441 and the guide pusher 462 to keep moving in the direction away from the rollers 20 until the locate pins 462 are aligned with the first locate holes 161 and the head portions 462b are inserted into the first locates holes 161 respectively. In this way, the retractable bar 30 can be retracted, as shown in FIG. 11.

Because the movable carrier 100 is combined with the table saw 200, when the retractable bar 30 is extracted, the user can carry the table saw 200 conveniently. On the contrary, when the retractable bar 30 is retracted, it is spaceless. Besides, the framework 10 can protect the left, right, and front plates of the table saw 200 from collision. Moreover, the grip 32 is designed in the shape matching the slave piece 422 to render more laborsaving manipulation.

Although the present invention has been described with respect to a specific preferred embodiment thereof, it is no way limited to the details of the illustrated structures but changes and modifications may be made within the scope of the appended claims.

What is claimed is:

1. A movable carrier for carrying a table saw, comprising:
a framework for supporting and connection with said table saw, said framework having two parallel base struts, at least one of which has at least one locate hole running through a sidewall thereof;
two rollers pivotably attached to said framework;
a retractable bar having two extension tubes and a grip, each of said extension tubes being inserted into said corresponding base strut, said grip being connected with said extension tubes; and
a manipulation assembly having a switch, at least one link piece, and at least one locate piece, said switch being mounted to said grip and having a button shiftable between a drive position and a non-drive position, said at least one link piece movably inserted into an end of said corresponding extension tube, having a first end and a second end, said first end being connected with said switch, said at least one locate piece being movably mounted to the other end of said extension tube and connected with said second end of said at least one link piece; wherein
when said button is located at said drive position, said at least one locate piece disengages from said locate hole to be located at a non-lock position; when said button is located at said non-drive position, said at least one locate piece is inserted into said locate hole to be located at a lock position.

2. The movable carrier as defined in claim 1, wherein said grip comprises a chamber and an opening in communication with said chamber; said switch comprises at least one biasing member received in said chamber for providing a biasing force forcing said button to keep moving toward said non-drive position.

3. The movable carrier as defined in claim 2, wherein said grip comprises a part hogged toward said table saw; said opening is located at a midsection of said hogged part of said grip; said switch further comprises a slave piece pivotably attached to said grip and located in said chamber, said slave piece having two parts, one of which is stopped against said button and the other is pivotably attached to said first end of said at least one link piece.

4. The movable carrier as defined in claim 3, wherein said at least one link piece comprises a link and a guide pusher, said link having an end becoming said first end of said link piece and pivotably attached to said slave piece of said switch, said guide pusher being fixed to the other end of said link which becomes said second end of said link piece; said at least locate piece is connected with said guide pusher and shiftable between said non-lock and lock positions along the diametrical direction of said base strut.

5. The movable carrier as defined in claim 4, wherein said guide pusher comprises an inclined guide groove; said at least one locate piece comprises a limit piece and a head portion connected with said limit piece, said head portion corresponding to said at least one locate hole of said base strut.

6. The movable carrier as defined in claim 5, wherein said at least one locate hole comprises a first locate hole and a second locate hole; when said head portion enters said first locate hole, said grip approaches said framework; when said head portion enters said second locate hole, said grip is moved away from said framework.

7. The movable carrier as defined in claim 6 further comprising a plurality of pads, wherein at least one of said pads has a stopper; said base strut further comprises a through hole close to said second locate hole, whereby said stopper can be fixedly inserted into said through hole of said base strut for preventing said retractable bar from extraction from said base strut.

8. The movable carrier as defined in claim 7, wherein at least one of said pads comprises a bevel.

9. The movable carrier as defined in claim 1, wherein said framework comprises a first strut and a second strut, which are vertically connected with said two base struts; said table saw comprises a left plate connected with said first strut, a right plate connected with said second strut, and a front plate connected between said first and second struts.

10. The movable carrier as defined in claim 1 further comprising two guide sleeves, each of which has two ends fitted onto an end of said base strut and an end of said extension tube respectively.
